(19) United States
(12) Patent Application Publication
(10) Pub. No.: US 2012/0111713 A1
(43) Pub. Date: May 10, 2012

(54) PORTABLE ELECTRONIC DEVICE AND PRINTED CIRCUIT BOARD MODULE

(75) Inventors: Tomonori SAKURAI, Kawasaki (JP); Yoshitaka SAKATA, Kawasaki (JP); Chikara KOBAYASHI, Kato (JP); Jiro TAKAHASHI, Kawasaki (JP)

(73) Assignee: FUJITSU LIMITED, Kawasaki-shi (JP)

(21) Appl. No.: 13/290,337

(22) Filed: Nov. 7, 2011

(30) Foreign Application Priority Data
Nov. 8, 2010 (JP) 2010-250065

(51) Int. Cl. H01H 1/10

(52) U.S. Cl. 200/517

(57) ABSTRACT

A portable electronic device includes a printed circuit board module including a printed circuit board, a contact switch disposed on the printed circuit board, and a sheet having a first portion attached to the contact switch and a surface of the printed circuit board on which the contact switch is disposed, a folded portion which is extended from the first sheet portion and folded back at an edge surface of the printed circuit board, and a second portion which is extended from the folded portion and attached to a back surface of the surface of the printed circuit board on which the contact switch is disposed, a key module including a key top provided on the sheet opposite to the contact switch, and a pusher which is provided between the key top and the contact switch, and a housing.

### CROSS-REFERENCE TO RELATED APPLICATIONS

This application is based upon and claims the benefit of priority of the prior Japanese Patent Application No. 2010-250065, filed on Nov. 8, 2010, the entire contents of which are incorporated herein by reference.

### FIELD

The embodiment discussed herein is related to a portable electronic device and a printed circuit board module.

### BACKGROUND

Conventionally, various keys are provided on a portable electronic device such as a mobile phone as an input interface of the device, and various operations are performed when the keys are pressed by a user. It is known that, for example, a key structure using contact switches is employed in electronic devices.

The key structure using contact switches includes a printed circuit board module in which contact switches are arranged on a printed circuit board on which an electronic circuit is formed and a key module arranged on the printed circuit board module. The key module includes, for example, a rubber sheet of an elastic material arranged on the printed circuit board module and key tops arranged on the rubber sheet. The rubber sheet has concave-shaped recesses formed at positions corresponding to contact switches on a surface facing the printed circuit board module. Thereby, thick portions and thin portions are formed in the rubber sheet. The thick portions are placed on the printed circuit board module to support and float the thin portions. A pusher having a protruded shape is formed on a surface of the thin portion facing the contact switch, and a key top is placed on the upper side of the thin portion. When a user presses the key top, the thin portion of the rubber sheet sags and the pusher moves toward the contact switch to press the contact switch.

As a contact switch of the printed circuit board module, for example, a metal dome, which is obtained by forming an electrical conductive material into a dome shape, may be used as described in Japanese Laid-open Patent Publication No. 2009-32588. In this case, top portions of the metal domes are attached to an insulating protective sheet in advance and the protective sheet is attached to the printed circuit board. Thereby, the metal domes are accurately arranged at positions where contact points for the metal domes are formed on the printed circuit board. Further, the surface of the printed circuit board on which the metal domes are arranged is covered by the protective sheet, so that the metal domes are prevented from being exposed in the printed circuit board module. Thus, it is possible to protect the metal domes and secure insulation properties of the metal domes.

But, improving dust resistance of the printed circuit board module and downsizing of the printed circuit board module are not discussed in the above document. The metal dome arranged at an edge portion of the printed circuit board module disclosed in the above document may be pushed many times. It may weaken the dust resistance of the printed circuit board module by peeling off of the edge portion of the protective sheet attached to the printed circuit board from the printed circuit board.

It is known that, in a conventional printed circuit board module, metal domes are provided in an area a predetermined distance (for example, 1.6 mm to 1.8 mm) inside the edges of the printed circuit board. Also, it is known that, when the contact switch is arranged at an edge portion of the printed circuit board, a predetermined distance is secured between the metal dome and the edges of the printed circuit board, so that the protective sheet is prevented from peeling off.

### SUMMARY

According to an aspect of an embodiment, a portable electronic device includes a printed circuit board module including a printed circuit board, a contact switch disposed on the printed circuit board, and a protective sheet having a first sheet portion attached to the contact switch and a surface of the printed circuit board on which the contact switch is disposed, a folded portion which is extended from the first sheet portion and folded back at an edge surface of the printed circuit board, and a second sheet portion which is extended from the folded portion and attached to a back surface of the surface of the printed circuit board on which the contact switch is disposed, a key module including a key top provided on the protective sheet opposite to the contact switch, and a pusher having a protruded shape, which is provided between the key top and the contact switch, moves toward the contact switch along with a movement of the key top toward the contact switch, and presses the contact switch, and a housing for accommodating the printed circuit board module and the key module.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view illustrating an appearance of a mobile phone of an embodiment in a state in which a display housing is not slid and the mobile phone is closed;

FIG. 2 is a perspective view illustrating an appearance of the mobile phone of the embodiment in a state in which the display housing is slid and the mobile phone is opened;

FIG. 3 is an exploded perspective view of the display housing of the mobile phone of the embodiment;

FIG. 4 is a plan view of a key flexible printed circuit;

FIG. 5 is a plan view of a base tape;

FIG. 6 is a plan view of a top tape;

FIG. 7 is a cross-sectional view of a dome switch portion of a printed circuit board module;

FIG. 8 is a diagram illustrating another embodiment of a contact switch of the printed circuit board module;

FIG. 9 is a perspective view of the printed circuit board module as seen from the front surface;

FIG. 10 is an enlarged view of a part of an edge portion of the front surface of the printed circuit board module;

FIG. 11 is a perspective view of the printed circuit board module as seen from the back surface;

FIG. 12 is an enlarged view of a part of an edge portion of the back surface of the printed circuit board module;

FIG. 13 is a diagram illustrating a second embodiment of the printed circuit board module;

FIG. 14 is a diagram illustrating a third embodiment of the printed circuit board module;

FIG. 15 is a diagram illustrating a fourth embodiment of the printed circuit board module;

FIG. 16 is a diagram illustrating the fourth embodiment of the printed circuit board module; and

FIG. 17 is a diagram illustrating a fifth embodiment of the printed circuit board module.

### DESCRIPTION OF EMBODIMENTS

Embodiments of an electronic device and a printed circuit board module disclosed in the present application will be described in detail with reference to the drawings. The disclosed techniques are not limited by the embodiments. For example, a mobile phone is described as an example of the electronic device in the embodiments described below, however, it is not limited to this, and the embodiments described below can be applied to any electronic device including a printed circuit board module equipped with contact switches, such as a PDA (Personal Digital Assistant).

### First Embodiment

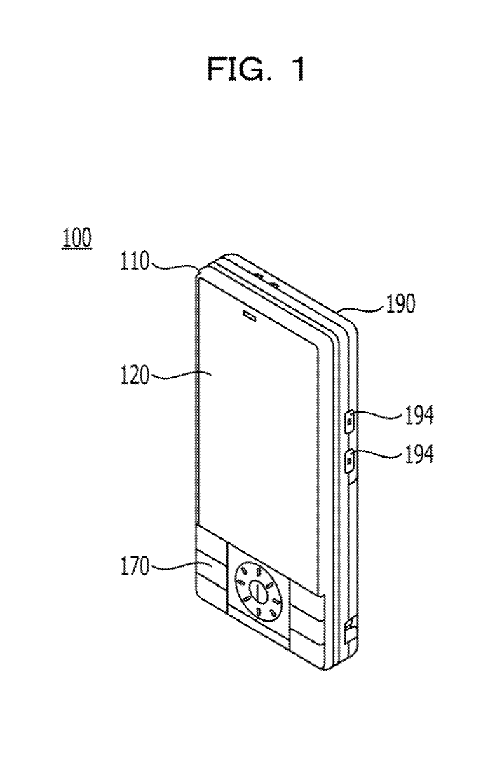

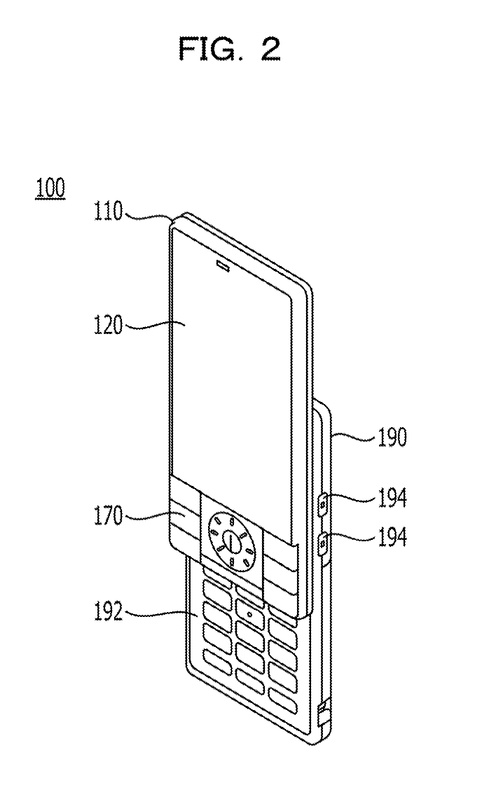

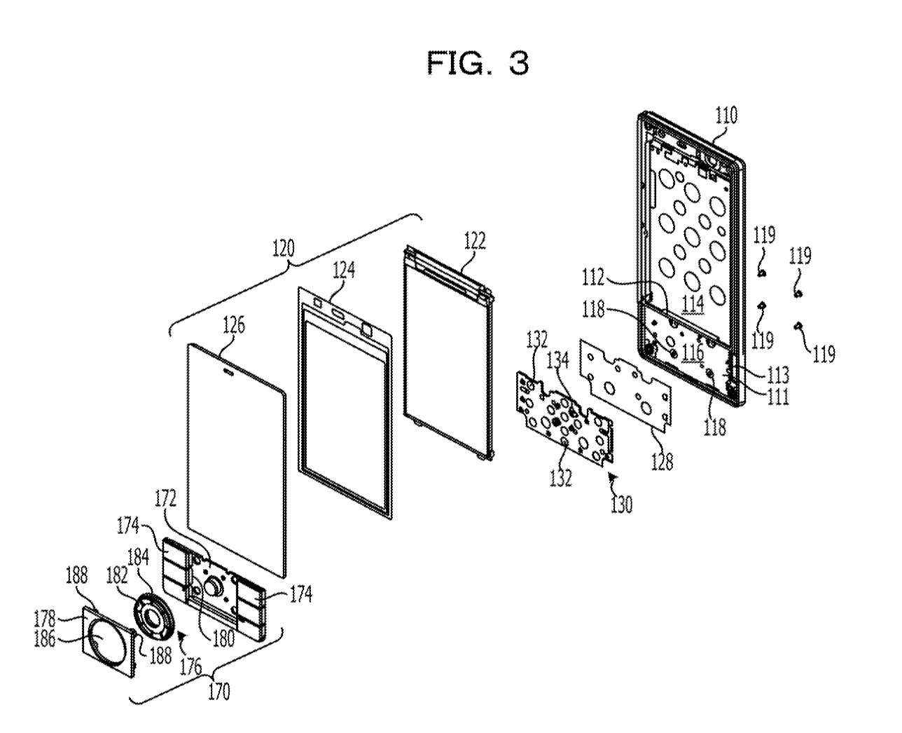

FIG. 1 is a perspective view illustrating an appearance of a mobile phone of the present embodiment in a state in which a display housing is not slid and the mobile phone is closed. FIG. 2 is a perspective view illustrating an appearance of the mobile phone of the present embodiment in a state in which the display housing is slid and the mobile phone is opened. FIG. 3 is an exploded perspective view of the display housing of the mobile phone of the present embodiment. As illustrated in FIGS. 1 and 2, a mobile phone 100 of the present embodiment includes a display housing 110 and an operation housing 190. The display housing 110 and the operation housing 190 are slidably connected to each other via a sliding mechanism not illustrated in the drawings FIG. 1 illustrates a closed state in which the display housing 110 is not slid and the display housing 110 and the operation housing 190 entirely overlap each other. FIG. 2 illustrates an open state in which the display housing 110 is slid and the display housing 110 and the operation housing 190 overlap each other in a minimum overlap area.

As illustrated in FIG. 3, one surface of the display housing 110 is opened. A partition wall 111 dividing the internal space of the display housing 110 into a space on the side of the opening and a space on the side of the bottom is provided in the display housing 110. A partition wall 112 dividing the space on the side of the opening into two spaces along a sliding direction of the mobile phone is disposed upright on a surface of the partition wall 111 on the side of the opening. The space on the side of the opening is divided into a first space 114 accommodating components and a second space 116 by the partition wall 112. A display unit 120 is accommodated in the first space 114. The second space 116 accommodates a printed circuit board module 130 attached to the front surface of the partition wall 111 via a double-sided tape 128 and a front key module 170 arranged on the printed circuit board module 130. The front key module 170 is an operation module for performing various operations of the mobile phone 100.

The display unit 120 includes a display module 122, packing 124, a display panel 126 such as a liquid crystal display panel. The display module 122 is accommodated on the front surface of the partition wall 111 and the display panel 126 is overlapped on the display module 122 via the packing 124. The packing 124 is inserted between the display panel 126 and the display module 122 and seals the circumference of the display surface of the display module 122. Thereby, foreign objects can be prevented from penetrating between the display panel 126 and the display surface of the display module 122. The packing 124 separates the display panel 126 from the display surface of the display module 122 and prevents display blur, which is caused when the display panel 126 comes into contact with the display surface, from occurring.

A plurality of contact switches such as metal domes 132 are provided and various components such as a plurality of LEDs 134 (Light Emitting Diodes) are mounted on a surface of the printed circuit board module 130 facing the front key module 170. The details of the printed circuit board module 130 will be described later.

The front key module 170 includes a rectangular base rubber 172 placed on the printed circuit board module 130 and a plurality of key tops 174 attached to the base rubber 172. The front key module 170 also includes a multi-directional input unit 176 attached to the base rubber 172 and a cover 178 provided on the base rubber 172. The base rubber 172 has concave-shaped recesses formed at positions corresponding to the metal domes 132 on a surface facing the printed circuit board module 130. Thereby, thick portions and thin portions are formed in the base rubber 172. The thick portions are placed on the printed circuit board module 130 to support and float the thin portions. A pusher having a protruded shape is formed on a surface of the thin portion facing the metal dome 132, and a key top 174 is attached to the upper side of thin portion. When a user presses the key top 174, the thin portion of the base rubber 172 sags and the pusher moves toward the metal dome 132 to press the metal dome 132.

The plurality of key tops 174 are attached to the thin portions of the base rubber 172 along three sides of the base rubber 172. Flanges 180 protruding toward the center of the base rubber 172 from a side surface of the base rubber 172 facing the center of the base rubber 172 are respectively formed on the plurality of key tops 174. The multi-directional input unit 176 includes a base unit 182 formed into a doughnut shape and a flange 184 protruding from the outer circumference of the base unit 182. The multi-directional input unit 176 is attached to approximately the center of the base rubber 172. The multi-directional input unit 176 is an input unit including a rotation operation encoder by which operations for rotating, pressing down, and tilting can be performed.

The cover 178 is formed into a rectangular plate shape. A through-hole 186 through which the base unit 182 of the multi-directional input unit 176 penetrates is formed in the center of the cover 178. A threaded hole 188 is formed at four corners on a surface of the cover 178 facing the display housing 110. The cover 178 is fixed to the display housing 110 when screws 119 inserted from screw through holes 118 formed in the back surface of the display housing 110 are screwed with the threaded holes 188. When the cover 178 is fixed to the display housing 110, the cover 178 comes into contact with the flanges 180 of the key tops 174 and the flange 184 of the multi-directional input unit 176, so that the key tops 174 and the multi-directional input unit 176 are prevented from being detached.

The key module 192 for performing various operations of the mobile phone 100 is accommodated in the operation housing 190. Also, the operation housing 190 accommodates a main body printed circuit board module on which components for performing various processing, such as signal processing related to communication of the mobile phone 100 and signal processing for displaying characters and images on the display panel, are mounted. An operation key 194 for, for example, adjusting a sound volume is provided on the side surface of the operation housing 190.

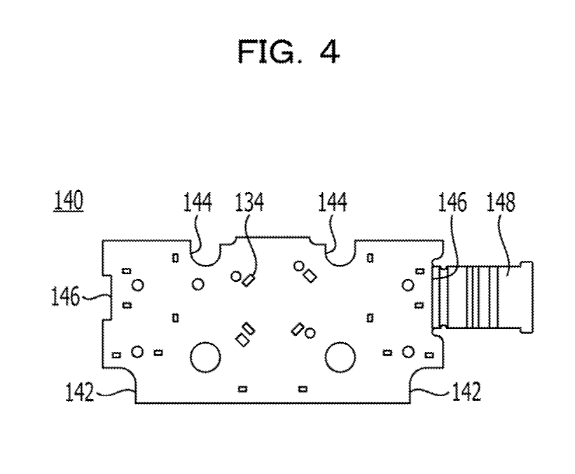

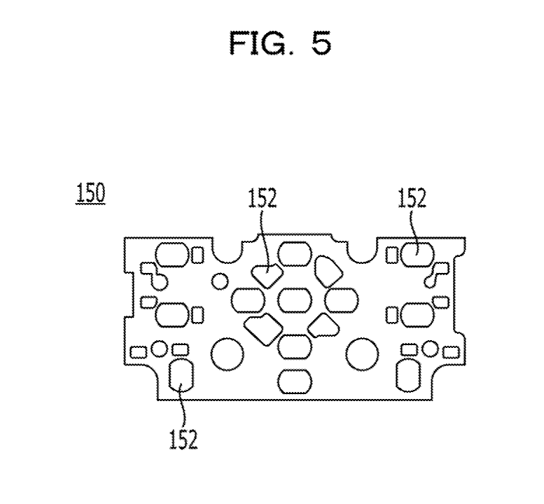

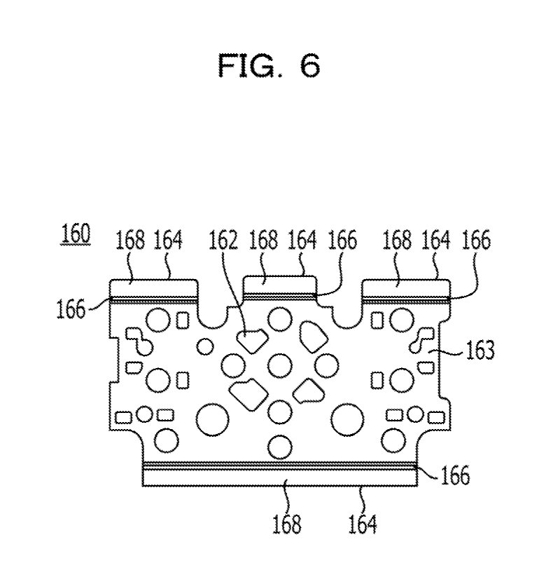

Next, the details of the printed circuit board module 130 will be described. FIG. 4 is a plan view of a key flexible printed circuit. FIG. 5 is a plan view of a base tape. FIG. 6 is a plan view of a top tape. The printed circuit board module 130 includes a key flexible printed circuit 140, a base tape 150, and a top tape 160 illustrated in FIGS. 4, 5, and 6. FIGS. 4, 5, and 6 illustrate a state before the printed circuit board module 130 is assembled.

The key flexible printed circuit 140 is a flexible printed circuit board formed of a PET sheet or the like. Various components such as an LED 134 are mounted on the key flexible printed circuit 140 and a wiring pattern is formed on the key flexible printed circuit 140. The flexible printed circuit board is a kind of printed circuit board. The key flexible printed circuit 140 is formed into a substantially rectangular shape and a notch 142 is formed at corners of both ends of one long side. Notches 144 are formed on the other side for the screws 119 to pass through. Notches 146 are respectively formed on short sides facing each other, and a key flexible printed circuit cable 148 is provided to the notch 146 on one short side. The key flexible printed circuit cable 148 is folded back to the back surface of the partition wall 111 through a gap 113 formed between the side surface of the partition wall 111 and the side surface of the display housing 110, and connected to a connector mounted on another printed circuit board provided on the back surface of the partition wall 111.

The base tape 150 is formed of a PET sheet or the like, covers the surface of the key flexible printed circuit 140 facing the front key module 170, and is attached to the key flexible printed circuit 140. Component holes 152 are formed in the base tape 150 at positions corresponding to shapes of various components such as an LED and positions corresponding to the metal domes 132 attached to the top tape 160. The outer shape of the base tape 150 is basically formed corresponding to the outer shape of the key flexible printed circuit 140. The size of the base tape 150 is formed so that the circumference surface of the base tape 150 is slightly inside the circumference surface of the key flexible printed circuit 140.

The top tape 160 is formed of an insulating material such as a PET sheet. The top tape 160 has a front surface adhesive portion 163 that covers the surface of the base tape 150 facing the front key module 170 and is attached to the base tape 150. In other words, the front surface adhesive portion 163 covers the surface of the key flexible printed circuit 140 on which the metal domes 132 are arranged. Component holes 162 are formed in the front surface adhesive portion 163 at positions corresponding to shapes of various components such as an LED and the top portions of the metal domes 132, which are formed of an electrically conducting material and formed into a dome shape, are attached to the surface of the front surface adhesive portion 163 facing the base tape 150.

The top tape 160 has folded portions 166 which extend from the front surface adhesive portion 163 and are folded back at the edge surfaces of the long sides of the key flexible printed circuit 140 at sides corresponding to the long sides of the key flexible printed circuit 140. Also, the top tape 160 has back surface adhesive portions 168 which extend from the folded portions 166 and are attached to the back surface of the component-mounted surface of the key flexible printed circuit 140. In other words, the outer shape of the top tape 160 is basically formed corresponding to the outer shape of the key flexible circuit 140, however, the folded portions 166 and the back surface adhesive portions 168 are formed at sides corresponding to the long sides of the key flexible printed circuit 140. Thereby, when the key flexible printed circuit 140 and the top tape 160 are overlapped together, the folded portions 166 and the back surface adhesive portions 168 protrude outside from the edge surfaces of the key flexible printed circuit 140.

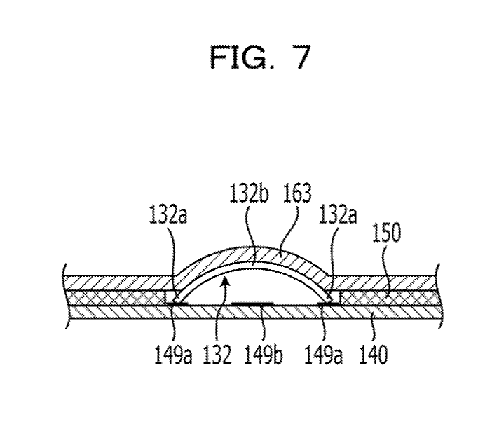

FIG. 7 is a cross-sectional view of a dome switch portion of the printed circuit board module. As illustrated in FIG. 7, the base tape 150 is attached to the key flexible printed circuit 140 and the front surface adhesive portion 163 on which the top portions of the metal domes 132 are attached in advance is attached to the base tape 150. On the component-mounted surface of the key flexible printed circuit 140, first contact points 149a are formed at points corresponding to the edge portions 132a of the metal domes 132 and second contact points 149b are formed at points facing the top portions 132b of the metal domes 132. The component holes 152 are formed in the base tape 150 at positions corresponding to the metal domes 132. The base tape 150 is attached to the key flexible printed circuit 140 in areas other than the metal domes 132. The top portions 132b of the metal domes 132 are attached to the front surface adhesive portion 163 facing the key flexible printed circuit 140. The front surface adhesive portion 163 is attached to the base tape 150 so that the edge portions 132a of the metal domes 132 come into contact with the first contact points 149a.

In this way, in a normal state, the edge portion 132a of the metal dome 132 and the first contact point 149a are in contact with each other and the top portion 132b of the metal dome 132 and the second contact point 149b are separated from each other. Therefore, the first contact point 149a and the second contact point 149b are insulated from each other. On the other hand, when the key top 174 is pressed by a user, the pusher formed on the thin portion of the base rubber 172 presses down the top portion 132b of the metal dome 132 via the front surface adhesive portion 163 and the metal dome 132 is deformed so that the top portion 132b is squashed. Thereby, the top portion 132b of the metal dome 132 comes into contact with the second contact point 149b, and the first contact point 149a and the second contact point 149b are electrically connected to each other. When the user stops pressing the key top 174, the metal dome 132 restores the shape to the state before the top portion 132b is squashed, and the first contact point 149a and the second contact point 149b are insulated from each other again.

### Another Embodiment of the Contact Switch of the Printed Circuit Board Module

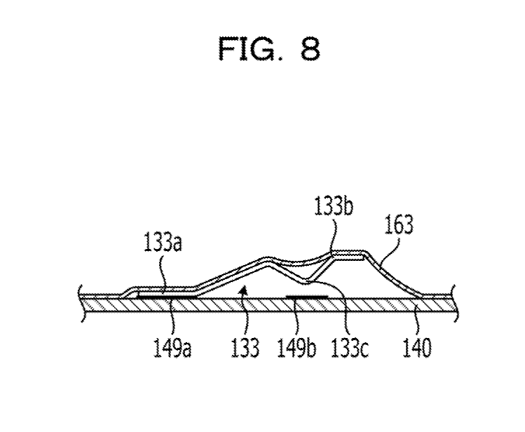

The contact switch of the printed circuit board module is not limited to the metal dome 132. FIG. 8 is a diagram illustrating another embodiment of the contact switch of the printed circuit board module. As illustrated in FIG. 8, the printed circuit board module 130 includes the key flexible printed circuit 140, a cantilever plate spring 133 arranged on the component-mounted surface of the key flexible printed circuit 140, and the front surface adhesive portion 163 of an insulating material covering the key flexible printed circuit 140 and the plate spring 133. The plate spring 133 includes a plate-shaped fixed portion 133a fixed to the first contact point 149a of the key flexible printed circuit 140 and a plate-shaped movable portion 133b obliquely extending from the edge portion of the fixed portion 133a in a direction going away from the key flexible printed circuit 140. The movable portion 133b is folded at the center in the extending direction so that a contact portion 133c protruding toward the key flexible printed circuit 140 is formed. The contact portion 133c is formed at a position corresponding to the second contact point 149b formed on the key flexible printed circuit 140.

In a normal state, the fixed portion 133a and the first contact point 149a are in contact with each other and the contact portion 133c and the second contact point 149b are separated from each other. Therefore, the first contact point 149a and the second contact point 149b are insulated from each other. On the other hand, when the key top 174 is pressed by a user, a pusher of the base rubber 172 presses down the contact portion 133c via the front surface adhesive portion 163. As a result, the contact portion 133c comes into contact with the second contact point 149b, and the first contact point 149a and the second contact point 149b are electrically connected to each other. When the user stops pressing the key top 174, the movable portion 133b rises by a restoring force of the plate spring 133 and the contact portion 133c and the second contact point 149b are separated from each other, so that the first contact point 149a and the second contact point 149b are insulated from each other again.

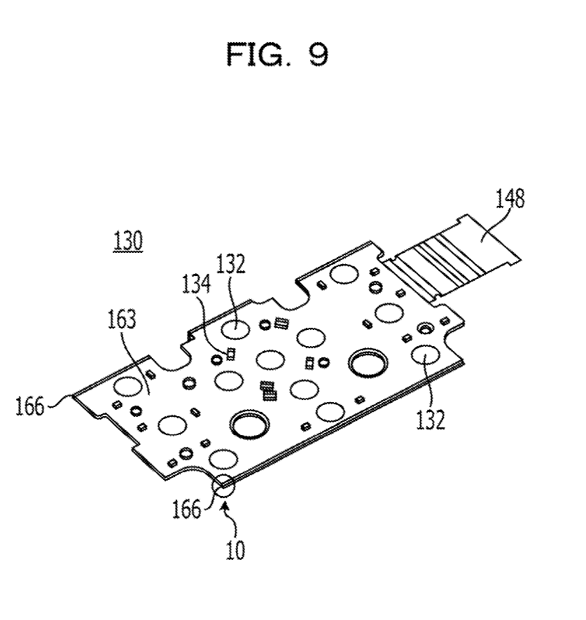

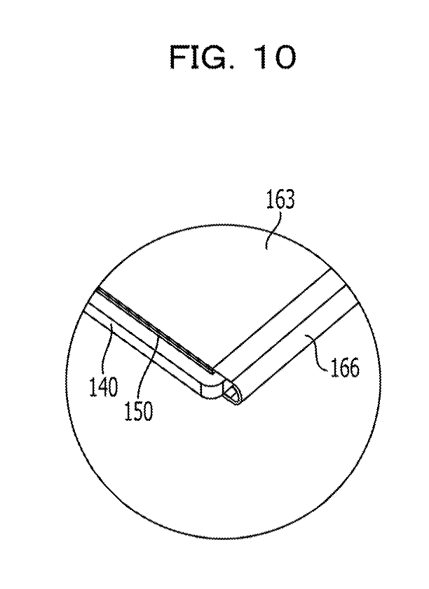

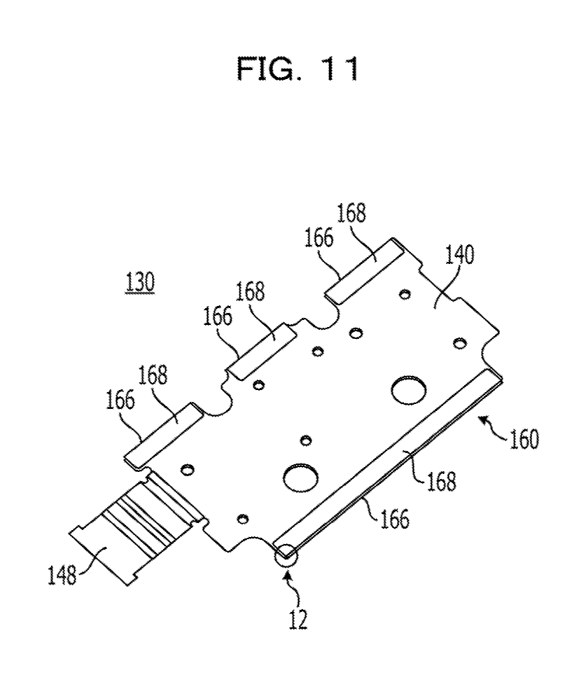

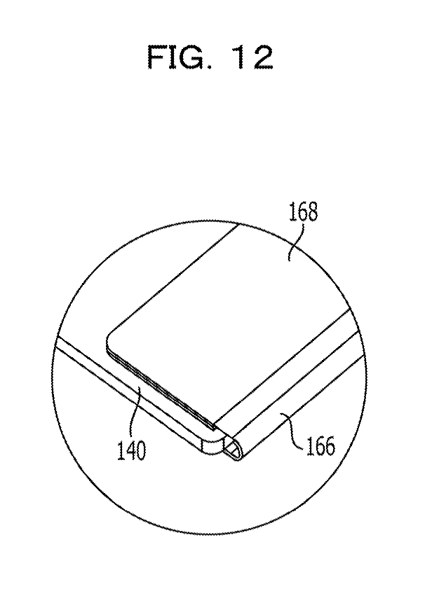

FIG. 9 is a perspective view of the printed circuit board module as seen from the front surface. FIG. 10 is an enlarged view of a part of an edge portion of the front surface of the printed circuit board module. FIG. 11 is a perspective view of the printed circuit board module as seen from the back surface. FIG. 12 is an enlarged view of a part of an edge portion of the back surface of the printed circuit board module. FIG. 10 is an enlarged view of a portion indicated by an arrow 10 in FIG. 9. FIG. 12 is an enlarged view of a portion indicated by an arrow 12 in FIG. 11.

As illustrated in FIGS. 9 to 12, in the printed circuit board module 130 of the present embodiment, the folded portions 166 are folded back at the edge surfaces of the long sides of the key flexible printed circuit 140, and the back surface adhesive portions 168 are attached to the back surface of the component-mounted surface of the key flexible printed circuit 140. Thereby, the top tape 160 sandwiches the key flexible printed circuit 140 and the base tape 150 by the front surface adhesive portion 163 and the back surface adhesive portions 168. A folded back length of the back surface adhesive portions 168 can be appropriately selected so that the back surface adhesion portions 168 are not peeled off from the back surface of the key flexible printed circuit 140. For example, the length can be 3.0 mm or more.

As described above, according to the present embodiment, the top tape 160 is provided with the folded portions 166 and the back surface adhesive portions 168, so that it is possible to improve dust resistance of the printed circuit board module 130 as well as to realize downsizing of the printed circuit board module 130. Also, the top tape 160 is provided with the folded portions 166 and the back surface adhesive portions 168, so that it is possible to enhance areas where the top tape 160 is attached to the edge portions of the key flexible printed circuit 140. Also, the top tape 160 is provided with the folded portions 166 and the back surface adhesive portions 168, so that it is possible to enhance adhesive strength in the edge portions of the key flexible printed circuit 140. Therefore, according to the present embodiment, even if a metal dome 132 disposed in an edge portion of the key flexible printed circuit 140 is repeatedly pressed, it is possible to prevent the top tape 160 from peeling off from the edge portion of the key flexible printed circuit 140. As a result, it is possible to improve dust resistance of the printed circuit board module 130. In addition, according to the present embodiment, when the metal domes 132 are arranged in the edge portions of the key flexible printed circuit 140, it is not necessary to set a predetermined distance (for example, 1.6 mm to 1.8 mm) between the metal domes 132 and the edge surfaces of the key flexible printed circuit 140 as in a conventional manner. As a result, it is possible to realize downsizing of the printed circuit board module. Therefore, according to the present embodiment, it is possible to improve dust resistance of the printed circuit board module as well as to realize downsizing of the printed circuit board module.

The back surface adhesive portion 168 can be attached to at least a back surface of a position at which a metal dome 132 of the key flexible printed circuit 140 is disposed. Thereby, every time the metal dome 132 is pressed by a user via the key top 174, the back surface of the component-mounted surface of the key flexible printed circuit 140 presses the back surface adhesive portion 168, so that the adhesiveness between the key flexible printed circuit 140 and the back surface adhesive portion 168 is maintained and the back surface adhesive portion 168 becomes difficult to be peeled off.

### Second Embodiment

### Second Embodiment of the Printed Circuit Board Module

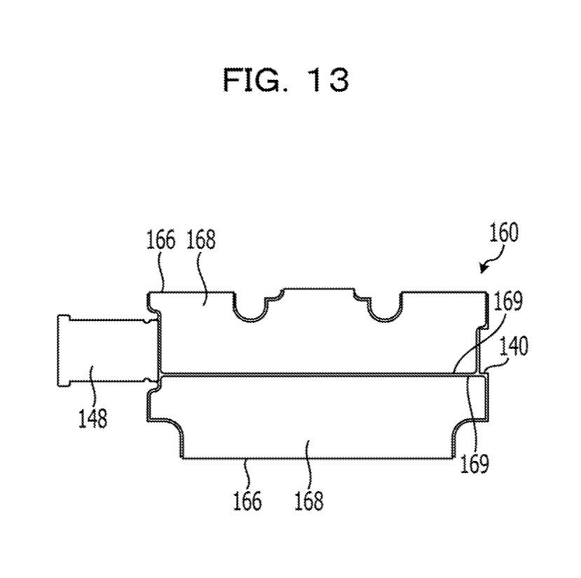

FIG. 13 is a diagram illustrating the second embodiment of the printed circuit board module. FIG. 13 is a plan view of the printed circuit board module as seen from the back surface. The key flexible printed circuit 140 and the base tape 150 are the same as those illustrated in FIGS. 4 and 5, so the description thereof will be omitted. The top tape 160 is different from that illustrated in FIG. 6 only in the shape of the back surface adhesive portion 168 and the other configuration is the same as that illustrated in FIG. 6, so the redundant description will be omitted.

As illustrated in FIG. 13, in the top tape 160, the folded portions 166 are formed at the sides corresponding to the long sides of the key flexible printed circuit 140, and the back surface adhesive portions 168 are attached to the back surface of the component-mounted surface of the key flexible printed circuit 140. Here, the back surface adhesive portions 168 are attached to cover the entire back surface of the component-mounted surface of the key flexible printed circuit 140 instead of a part of the back surface of the component-mounted surface of the key flexible printed circuit 140. In other words, in the top tape 160, the folded portions 166 are respectively formed at the edge surfaces of the two sides of the key flexible printed circuit 140 facing each other, and edge surfaces 169 of the back surface adhesive portions 168 extended from the folded portions 166 face each other on the back surface of the component-mounted surface of the key flexible printed circuit 140. More specifically, the edge surfaces 169 of the back surface adhesive portions 168 face each other near the intermediate line between the long sides of the back surface of the component-mounted surface of the key flexible printed circuit 140.

In this way, the back surface adhesive portions 168 are attached to cover the entire back surface of the component-mounted surface of the key flexible printed circuit 140 instead of a part of the back surface of the component-mounted surface of the key flexible printed circuit 140, so that the back surface adhesive portions 168 can be more difficult to be peeled off from the key flexible printed circuit 140. Further, the edge surfaces 169 of the back surface adhesive portions 168 face each other near the intermediate line between the long sides of the back surface of the component-mounted surface of the key flexible printed circuit 140, so that it is possible to prevent unevenness from occurring between the back surface adhesive portions 168 and the back surface of the component-mounted surface of the key flexible printed circuit 140.

### Third Embodiment

### Third Embodiment of the Printed Circuit Board Module

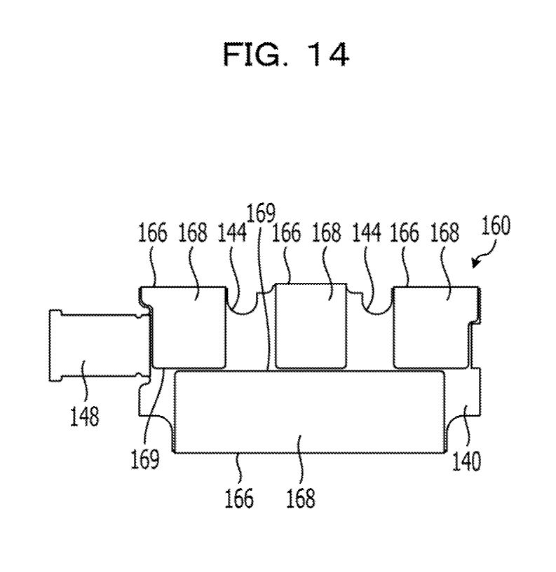

FIG. 14 is a diagram illustrating the third embodiment of the printed circuit board module. FIG. 14 is a plan view of the printed circuit board module as seen from the back surface. The key flexible printed circuit 140 and the base tape 150 are the same as those illustrated in FIGS. 4 and 5, so the description thereof will be omitted. The top tape 160 is different from that illustrated in FIG. 6 only in the shape of the back surface adhesive portion 168 and the other configuration is the same as that illustrated in FIG. 6, so the redundant description will be omitted.

As illustrated in FIG. 14, in the top tape 160, the folded portions 166 are formed at the sides which correspond to the long sides of the key flexible printed circuit 140 and from which portions of the notches 144 are excluded, and the back surface adhesive portions 168 are attached to the back surface of the component-mounted surface of the key flexible printed circuit 140. Also, in this case, the edge surfaces 169 of the back surface adhesive portions 168 extended from the folded portions 166 face each other near the intermediate line between the long sides of the back surface of the component-mounted surface of the key flexible printed circuit 140.

Thereby, the back surface adhesive portions 168 can be difficult to be peeled off from the key flexible printed circuit 140 and an operation for folding back the back surface adhesive portions 168 can be easy.

### Fourth Embodiment

### Fourth Embodiment of the Printed Circuit Board Module

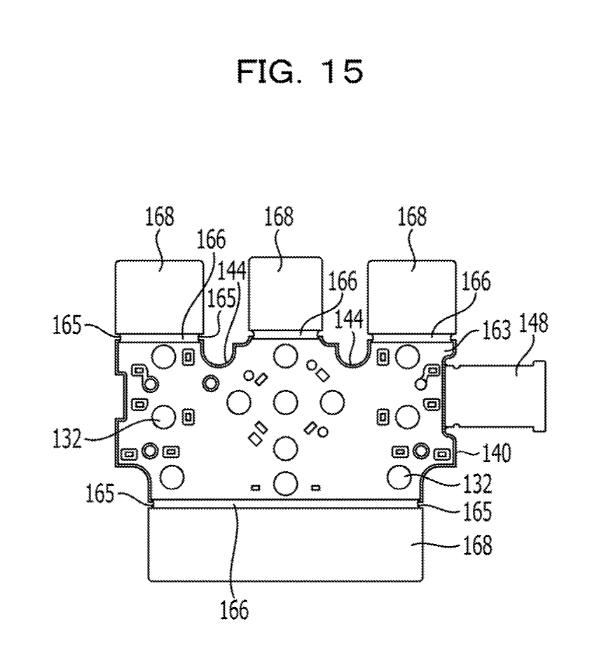

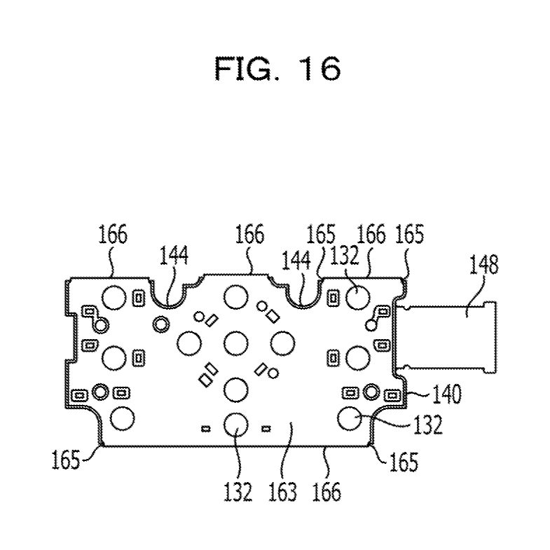

FIGS. 15 and 16 are diagrams illustrating the fourth embodiment of the printed circuit board module. FIG. 15 is a plan view of the printed circuit board module in a state in which the folded portions are not folded back. FIG. 16 is a plan view of the printed circuit board module in a state in which the folded portions are folded back. The key flexible printed circuit 140 and the base tape 150 are the same as those illustrated in FIGS. 4 and 5, so the description thereof will be omitted. The top tape 160 is different from that illustrated in FIG. 14 only in the shapes of the folded portions 166 and the other configuration is the same as that illustrated in FIG. 14, so the redundant description will be omitted.

As illustrated in FIGS. 15 and 16, in the top tape 160, the folded portions 166 are formed at positions corresponding to the edge surfaces of the long sides of the key flexible printed circuit 140 excluding the notches 144. A semicircular notch 165 is formed at both ends of the folded portions 166 along the direction of the long sides of the key flexible printed circuit 140.

In this way, the notches 165 are formed in the folded portions 166, so the operation for folding back the back surface adhesive portions 168 becomes easy. The notch 165 is not limited to have a semicircular shape, and for example, a V-shaped notch can be made.

Although, in the embodiments described above, the printed circuit board module 130 including the key flexible printed circuit 140, which is a flexible printed circuit board, is described, the constituent element of the printed circuit board module 130 is not limited to the flexible printed circuit board. The constituent element of the printed circuit board module 130 may be a rigid printed circuit board as described below.

### Fifth Embodiment

### Fifth Embodiment of the Printed Circuit Board Module

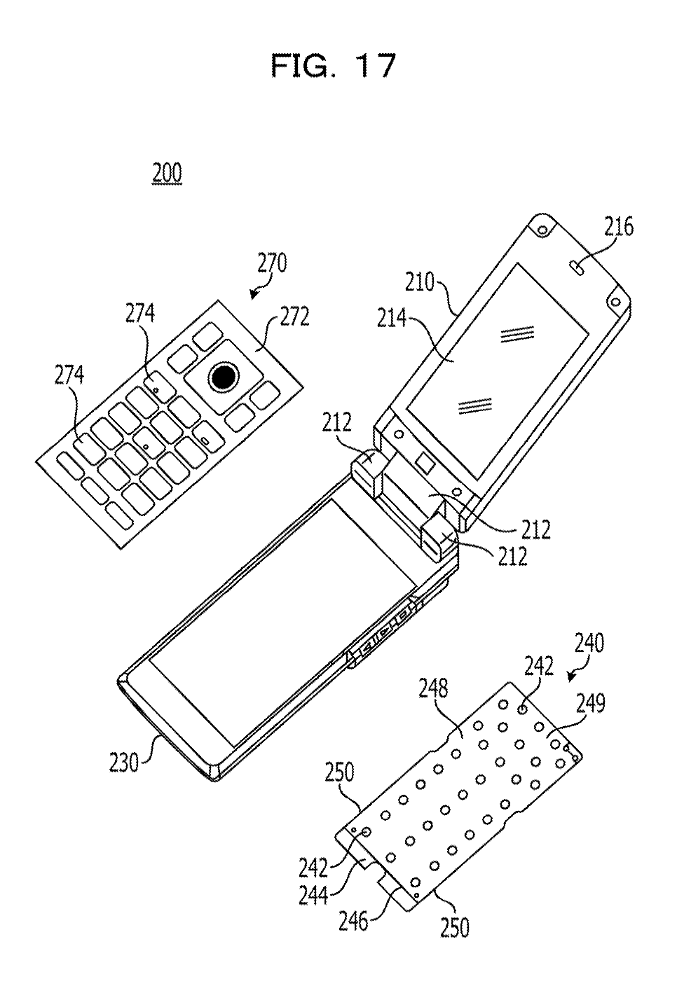

FIG. 17 is a diagram illustrating the fifth embodiment of the printed circuit board module. As illustrated in FIG. 17, a mobile phone 200 of the present embodiment includes a display housing 210 and an operation housing 230. The display housing 210 and the operation housing 230 are openably and closably connected to each other via a hinge mechanism 212. The mobile phone 200 is a foldable mobile phone. FIG. 17 illustrates a state in which the display housing 210 and the operation housing 230 are opened to each other.

The display housing 210 accommodates a display unit 214 and a speaker 216. The display unit 214 is the same as the display unit 120 described in FIGS. 1 to 3, so the description thereof will be omitted. The operation housing 230 accommodates a printed circuit board module 240 and a key module 270.

A plurality of contact switches such as metal domes 242 are provided on a surface of the printed circuit board module 240 facing the key module 270. The key module 270 includes a rectangular base rubber 272 placed on the printed circuit board module 240 and a plurality of key tops 274 attached to the base rubber 272. The base rubber 272 has concave-shaped recesses formed at positions corresponding to the metal domes 242 on a surface facing the printed circuit board module 240. Thereby, thick portions and thin portions are formed in the base rubber 272. The thick portions are placed on the printed circuit board module 240 to support and float the thin portions. A pusher having a protruded shape is formed on a surface of the thin portion facing the metal dome 242, and a key top 274 is attached to the upper side of thin portion. When a user presses the key top 274, the thin portion of the base rubber 272 sags and the pusher moves toward the metal dome 242 to press the metal dome 242.

The printed circuit board module 240 includes a rigid printed circuit board 244 on which contact switches such as the metal domes 242 and various components are mounted and a base tape 246 that covers the component-mounted surface of the rigid printed circuit board 244. Further, the printed circuit board module 240 includes a top tape 248 that covers the base tape 246. The printed circuit board module 240 has basically the same configuration as that of the printed circuit board module 130 except that the key flexible printed circuit 140 of the printed circuit board module 130 of the above-described embodiments is replaced by the rigid printed circuit board 244.

Specifically, the base tape 246 is formed of a PET sheet or the like, covers the surface of the rigid printed circuit board 244 facing the key module 270, and is attached to the rigid printed circuit board 244. Component holes are formed in the base tape 246 at positions corresponding to shapes of various components such as the metal domes 242. The outer shape of the base tape 246 is basically formed corresponding to the outer shape of the rigid printed circuit board 244. The size of the base tape 246 is formed so that the circumference surface of the base tape 246 is slightly inside the circumference surface of the rigid printed circuit board 244.

The top tape 248 is formed of an insulating material such as a PET sheet. The top tape 248 has a front surface adhesive portion 249 that covers the surface of the base tape 246 facing the key module 270 and is attached to the base tape 246. In other words, the front surface adhesive portion 249 covers the surface of the rigid printed circuit board 244 on which the metal domes 242 are arranged. The top portions of the metal domes 242, which are formed of an electrically conducting material and formed into a dome shape, are attached to the surface of the front surface adhesive portion 249 facing the base tape 246.

The top tape 248 has folded portions 250 which extend from the front surface adhesive portion 249 and are folded back at the edge surfaces of the long sides of the rigid printed circuit board 244 at sides corresponding to the long sides of the rigid printed circuit board 244. Also, the top tape 248 has back surface adhesive portions which extend from the folded portions 250 and are attached to the back surface of the component-mounted surface of the rigid printed circuit board 244. In other words, the outer shape of the top tape 248 is basically formed corresponding to the outer shape of the rigid printed circuit board 244, however, the folded portions 250 and the back surface adhesive portions are formed at sides corresponding to the long sides of the rigid printed circuit board 244. Thereby, when the rigid printed circuit board 244 and the top tape 248 are overlapped together, the folded portions 250 and the back surface adhesive portions protrude outside from the edge surfaces of the rigid printed circuit board 244.

The back surface adhesive portions of the top tape 248 are attached to the back surface of the component-mounted surface of the rigid printed circuit board 244 in the same manner as illustrated in FIGS. 9 to 12. Thereby, the top tape 248 sandwiches the rigid printed circuit board 244 and the base tape 246 by the front surface adhesive portion 249 and the back surface adhesive portions. A folded back length of the back surface adhesive portions can be appropriately selected so that the back surface adhesion portions are not peeled off from the back surface. For example, the length can be 3.0 mm or more.

As described above, according to the present embodiment, the top tape is provided with the folded portions and the back surface adhesive portions, so that it is possible to improve dust resistance of the printed circuit board module as well as to realize downsizing of the printed circuit board module. Also, the top tape is provided with the folded portions and the back surface adhesive portions, so that it is possible to enhance areas where the top tape is attached to the edge portions of the printed circuit board. Also, the top tape is provided with the folded portions and the back surface adhesive portions, so that it is possible to enhance adhesive strength in the edge portions of the printed circuit board. Therefore, according to the present embodiment, even if a contact switch disposed in an edge portion of the printed circuit board is repeatedly pressed, it is possible to prevent the top tape from peeling off from the edge portion of the printed circuit board. As a result, it is possible to improve dust resistance of the printed circuit board module. In addition, according to the present embodiment, when the metal domes are arranged in the edge portions of the printed circuit board, it is not necessary to form the printed circuit board so that the printed circuit board has a size in which a predetermined distance (for example, 1.6 mm to 1.8 mm) between the metal domes and the edge surfaces of the printed circuit board is secured. As a result, it is possible to realize downsizing of the printed circuit board module. Therefore, according to the present embodiment, it is possible to improve dust resistance of the printed circuit board module as well as to realize downsizing of the printed circuit board module.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A portable electronic device comprising:
a printed circuit board module including
a printed circuit board,
a contact switch disposed on the printed circuit board, and
a protective sheet having a first sheet portion attached to the contact switch and a surface of the printed circuit board on which the contact switch is disposed, a folded portion which is extended from the first sheet portion and folded back at an edge surface of the printed circuit board, and a second sheet portion which is extended from the folded portion and attached to a back surface of the surface of the printed circuit board on which the contact switch is disposed;
a key module including
a key top provided on the protective sheet opposite to the contact switch, and
a pusher having a protruded shape, which is provided between the key top and the contact switch, moves toward the contact switch along with a movement of the key top toward the contact switch, and presses the contact switch; and
a housing for accommodating the printed circuit board module and the key module.

2. The portable electronic device according to claim 1, wherein
the second sheet portion of the protective sheet is attached to the back surface of the surface of the printed circuit board at least at a position where the contact switch is disposed.

3. The portable electronic device according to claim 1, wherein
the protective sheet has a opposite folded portion which is extended from the first sheet portion and folded back at an opposite edge surface opposite to the edge surface of the printed circuit board, and a opposite second sheet portion which is extended from the opposite folded portion and attached to the back surface of the surface of the printed circuit board on which the contact switch is disposed, and
a first edge surface of the second sheet portion and a second edge surface of the opposite second sheet portion face each other near an intermediate line on the back surface of the printed circuit board.

4. The portable electronic device according to claim 1, wherein the printed circuit board is a flexible printed circuit board or a rigid printed circuit board.

5. A printed circuit board module comprising:
a printed circuit board;
a contact switch disposed on the printed circuit board; and
a protective sheet having a first sheet portion attached to the contact switch and a surface of the printed circuit board on which the contact switch is disposed, a folded portion which is extended from the first sheet portion and folded back at an edge surface of the printed circuit board, and a second sheet portion which is extended from the folded portion and attached to a back surface of the surface of the printed circuit board on which the contact switch is disposed.
